(19) United States
(12) Patent Application Publication
(10) Pub. No.: US 2009/0311370 A1
(43) Pub. Date: Dec. 17, 2009

(54) Highly water-soluble agave inulin, agave inulin-containing product, agave inulin-origin product, by-product and method for producing the same

(75) Inventors: Tetsuya Ogura, Jalisco (MX); Celia Beltran, Jalisco (MX); Yoshitane Kojima, Osaka (JP)

Correspondence Address: QUINN EMANUEL;KODA & ANDROLIA, 865 S. FIGUEROA STREET, 10TH FLOOR, LOS ANGELES, CA, 90017, US

(73) Assignee: Agave Inc. and Universidad Autonoma de Guadalajara

(21) Appl. No.: 12/227,997

(22) PCT Filed: Jun. 7, 2007
(86) PCT No.: PCT/JP2007/061569

§ 371 Date: Dec. 4, 2008

(30) Foreign Application Priority Data
Jun. 8, 2006 (JP) 2006 159273

(51) Int. Cl. C12G 3/00; C13D 1/00; A23K 1/14; A23L 1/09

(52) U.S. Cl. 426/13; 127/36; 127/43; 426/11; 426/592; 426/635

(57) ABSTRACT

Inulin, which is contained at a high concentration in agave plants growing in arid areas, has been utilized hitherto exclusively in producing alcoholic drinks as tequila. It is intended to produce highly water-soluble inulin having a high added value from these plants. It is also intended to produce an agave syrup, tequila, an alcoholic drink or highly water-soluble inulin from the squeezed residue. Agave plant bulbs (several tens kg) having been employed in producing tequila called pina are cut into small pieces and enzymes therein are inactivated and the texture is softened either at room temperature or under heating. Next, the pieces are squeezed to give a liquid extract which is then refined by using an adsorbent resin. The refined product is employed either as such as a concentrate or after drying to give a powder.

### FIELD OF THE INVENTION

The present invention relates to a production method of inulin of polysaccharide, and particularly relates to a purification and production method of inulin from agave plant which was not done conventionally at all and a recovery method of by-product in purification process.

### BACKGROUND ART

Inulin is a polysaccharide in which fructoses polymerize linearly or branch-shapedly and glucose couples with its terminal, the degree of polymerization of fructose distributes mainly on 10-40 and both ends of distribution reach to the range of 2-60. In Japan, asteraceae plant is known as a plant containing a large quantity of inulin and inulin of 15-20% is contained in the root of, for example, chicory (originally from Europe) and Jerusalem artichoke. In addition, inulin is also contained in garlic, gynmight, onion, dahlia, edible burdock, thistle etc.

Inulin is white and unscented carbohydrate powder with extremely low calorie value, and comes into the limelight as dietary fiber. Additionally, Inulin is useful for health increase such as intestinal regulation activity, hypocholesterolemic activity, glucose level rise depression action, mineral absorption acceleration function and lactobacillus bifidus breeding function, and it attracts attention as fat substitution product of mayonnaise and fresh cream.

However, for example, in Japanese Patent Laid-Open No. 2005-278459 (patent document 1), inulin-containing powder is produced by crushing, drying and roasting Jerusalem artichoke, but it is not a thing producing inulin simple substance. Moreover, in Japanese Patent Laid-Open No. 7-87990 (patent document 2), fructose polymer-containing plant such as Jerusalem artichoke is hydrolyzed so that soluble site is produced, and sugar alcohol of fructo-oligosaccharide can be produced by reducing it, but the degree of polymerization of fructose is 1-4 in fructo-oligosaccharide of this case, then inulin of high degree of polymerization cannot be produced by said method. Therefore, in Japanese Patent Laid-Open No. 2003-93090 (patent document 3), it is established the method that inulin is produced by acting inulin synthetic enzyme for sucrose, but inulin cannot be produced from sugar raw material plant at a stretch, so that it causes the result that inulin price jumps.

In particular, since inulin produced from asteraceae plant such as Jerusalem artichoke and chicory has low solubility, there exists a weak point that some powder tactile remains behind when it is made a juice. Accordingly, inulin is offered as powder and tablet in many cases, so that it has a weak point that it is hard to be taken in comparison with juice.

Therefore, apart from asteraceae plant, the present inventors paid their attention to agave plant that grows wild in Mexico. Mexico is dry climate and succulent agave plant similar to aloe grows stably in desert. Alcoholic drinks such as tequila and pulque are produced by alcoholic fermentation of agave plant, but it is known that the main body of fermentation in this case is high quality inulin included in agave plant with high concentration (non-patent document 1). Besides, because many agave plants are cultivated to produce these alcoholic fermentation products, and the stable supply and the well developed carrying net of agave plant can be used.

In the usually known production method of tequila (non-patent document 2), the pina of agave plant (corm part trimmed like a pineapple) is heated with steam of 100° C. for about 30 hours, so that inulin in the inside is hydrolyzed to fructose. While adding water to the pina being heated, it is squeezed with a squeezer so that sap is got. Alcoholic fermentation is done for this sap, and the fermentation liquid is distilled twice, so that tequila is produced.

A large quantity of heavy oil becomes necessary for said steam heating method, and the long time heat of 30 hours has become the reason for jumping the energy cost. In addition, the recent sudden remarkable rise of heavy oil price forms a vicious circle to bring about the sudden rise of the energy cost. Since tequila is the expensive brand liquor peculiar to Mexico, energy cost can only be absorbed. Additionally, even raw pina sap before heat is about pH 5, and the inside of pina becomes pH 4 to 4.5 by steam heat, so that inulin is hydrolyzed by acid and water for acceleration. Besides, most inulin is hydrolyzed up to fructose by hydrolysis of long time of about 30 hours. Because alcoholic fermentation is done for said fructose, in the production method of tequila, there is not thought to extract agave inulin as simple substance at all.

In addition, technology to extract fructose from agave plant is developed, too. That is to say, agave syrup being fructose syrup is produced by hydrolyzing of agave sap (patent document 4, patent document 5, patent document 6). However, in said production method of agave syrup, it is the purpose to extract fructose, but there is no idea to extract inulin from agave plant without hydrolyzing. Furthermore, in these production methods, it has not been considered to squeeze sap without adding water.
[Patent document 1] Japanese Patent Laid-Open No. 2005-278459
[Patent document 2] Japanese Patent Laid-Open No. 7-87990
[Patent document 3] Japanese Patent Laid-Open No. 2003-93090
[Patent document 4] U.S. Pat. No. 3,928,121
[Patent document 5] U.S. Pat. No. 4,138,272
[Patent document 6] U.S. Pat. No. 5,846,333
[Non-patent document 1] Srinivasan M, Bhatia I S, Carbohydrates of Agave Vera Cruz. Biochem Journal 1953, 55, 286-9
[Non-patent document 2]
http://www.rikukawa.com/jyouryusyu/tequila/manufacture.html

### DISCLOSURE OF THE INVENTION

### Problem to be Solved by the Invention

Patent documents 4-6 showing the production methods of agave syrup are analyzed in detail. In patent document 4, leaf and pina of agave plant are separated, both are mixed and crushed after washing them with water, and the sap is obtained. This sap is hydrolyzed and the supernatant is extracted by settling it. The hydrolysis is promoted by heating this supernatant, and with concentrating in vaporization process and spray-drying, the powder syrup is produced.

Since the sap is about pH 4, the hydrolysis promotes by acid, and because of non-heating at that stage, the inulin degrading enzyme acts so that hydrolysis of inulin proceeds acceleratedly. Besides, acid hydrolysis is promoted by heating of said supernatant, and most inulin changes to fructose, so that powder syrup is completed. Therefore, It is neither described or suggested that inulin simple substance is produced.

In patent document 5, it is characterized that the supernatant produced based upon patent document 4 is prepared to pH 3 to 4, and the acid hydrolysis is forcibly advanced by holding it at 85-100° C. for 2 to 3 hours. Finally, hydrolysis is stopped by neutralizing of said acid supernatant, and furthermore, it is refined by heating and treating of sais supernatant, so that agave syrup (fructose syrup) is produced by evaporative concentration.

The point that pH, temperature and resolving time were made clear is characteristic, and it is the purpose to hydrolyze inulin forcibly, therefore it is clear that the technical idea producing the inulin simple substance does not exist in patent document 5 at all.

In patent document 6, the sap is produced by squeezing the pina with adding of water, and this sap is refined by centrifugal process and removal of colloid, furthermore it is demineralized by activated carbon, cation exchange resin and anion exchange resin. Afterwards, inulin is forcibly hydrolyzed to fructose by inulin degrading enzyme so that agave syrup (fructose syrup) is produced.

The characteristic of patent document 6 is that hydrolysis is advanced by inulin degrading enzyme (inulinase) and that heat treatment is not carried out to activate the inulin degrading enzyme. Therefore, it is clear that the technical idea to produce inulin simple substance does not exist in patent document 6 at all.

As described above, in the production method of tequila and patent documents 4-6, it is their purpose to produce alcoholic drink and agave syrup from agave plant, the technology extracting inulin simple substance from agave plant is not disclosed at all, and it is the present situation that there is not even suggestion of inulin extraction.

While it has been known that inulin is contained with high concentration in agave plant, the idea to extract inulin simple substance from the agave plant was not considered conventionally at all. However, if inulin can be extracted from stably cultivated agave plant, inulin should be able to be supplied stably and cheaply.

Efficacy of inulin should be recognized again. It is well known that bowel which is apt to become dirtiest in the body undertakes an important role to absorb nutrient component included in food and probiotic bacterial flora such as bifidobacteria prevents propagation of harmful bacteria. Since most animals including mankind have not inulinase hydrolyzing inulin, the inulin included in food reaches the bowel without being digested, so that bifidobacteria secreting inulinase come to multiply, and it attracts more attention in late years to watch prebioticly, and the global demand of inulin grows rapidly.

On the other hand, water demand of world becomes tight (for example, Ministry of Land, Infrastructure and Transport, Water problem of world and Japan, Water problem of world to worsen), and the increase in production of agriculture to occupy 80% among the fresh water which mankind employs is considered to be the prime problem in order to feed population expected to reach nine billion people by 2050 year. The agave plant harvested in the desert zone is estimated to increase the importance in future. However, the rigid protection mechanism develops in plant growing on the dry ground, for example in the case of agave, the outside of plant is surrounded by sharp prickles and the inside is filled with the substance of firm fiber, and besides as the capillary crystals of calcium oxalate (raphide) are buried, touch to it causes dermatitis and itself cannot be offered for edible, so that inulin is extracted from agave plant and an offer to market as inulin is required necessarily.

Because agave plant is knit and crowded with fibrous material, it becomes very firm and it is hard to be squeezed. Besides, since inulin is saved in vacuole surrounded with cell wall, the cell wall and tonoplast must be crushed to extract inulin. Additionally, it is easy to hydrolyze inulin because of inulinase included in the plant. Moreover, there are terpene-like smell, grassy smell and bitterness because of chemical substance used for self-protection. Therefore, it is the problem of the present invention to solve these drawbacks.

### Means to Solve the Problem

The present invention is performed to solve above problem, and the first form of the present invention is a method for producing highly water-soluble agave inulin comprising the steps of: crushing vacuoles containing inulin by giving a force to a plant piece either while or after cutting an agave plant containing said inulin into said plant pieces, squeezing sap of said vacuoles from said crushed plant piece, and producing an agave inulin solution dissolving said highly water-soluble agave inulin by removing impurities from said sap.

The second form of the present invention, in said first form, the method for producing highly water-soluble agave inulin, wherein said plant piece is heated with a temperature of less than or equal to 100° C. during a desirable time in a range of 5 minutes to 180 minutes while and/or after cutting said agave plant.

The third form of the present invention, in said first or second form, is the method for producing highly water-soluble agave inulin, wherein said plant piece and/or said crushed plant piece are mixed with an acid neutralizer.

The fourth form of the present invention, in said first, second or third form, is the method for producing highly water-soluble agave inulin, wherein the treatment of said plant piece is carried out under the condition that water is not forcibly added.

The fifth form of the present invention, in any of said first to fourth forms, is the method for producing highly water-soluble agave inulin, wherein said sap is prepared in a range of pH 6-8.

The sixth form of the present invention, in any of said first to fifth forms, is the method for producing highly water-soluble agave inulin, wherein said impurities are adsorbed and removed from said sap by an adsorbent.

The seventh form of the present invention, in said sixth form, is the method for producing highly water-soluble agave inulin, wherein said impurities adsorbed by said adsorbent are eluted in a mixed solution of water and organic solvent, and said adsorbent is reused after said elution.

The eighth form of the present invention, in said seventh form, is the method for producing highly water-soluble agave inulin, wherein said eluted impurities are recovered as a by-product by distilling said mixed solution.

The ninth form of the present invention, in any of said first to eighth forms, is the method for producing highly water-soluble agave inulin, wherein solid agave inulin is produced by removing water from said agave inulin solution.

The tenth form of the present invention is an agave inulin solution characterized in that said agave inulin solution is produced by the production method according to any of said first to eighth forms.

The 11th form of the present invention is a solid agave inulin characterized in that said solid agave inulin is produced by the production method according to said ninth form.

The 12th form of the present invention is a by-product characterized in that said by-product is recovered by the production method according to said eighth form.

The 13th form of the present invention is an agave inulin extract characterized in that said agave inulin extract is obtained by extracting inulin through adding water or hot water to a pomace remained after said sap was squeezed by the production method according to any of said first to fourth forms.

The 14th form of the present invention is a method for producing an alcoholic drink characterized in that a sugar solution containing fructose as a main component is generated by hydrolyzing said agave inulin extract according to said 13th form by using of an acid catalyst or an enzyme, and said alcoholic drink is produced by distillation while or after fermenting said sugar solution.

The 15th form of the present invention is a method for producing an agave syrup characterized in that a sugar solution containing fructose as a main component is generated by hydrolyzing said agave inulin extract according to said 13th form by using of an acid catalyst or an enzyme, and said agave syrup is produced by concentrating said sugar solution.

The 16th and 17th forms of the present invention are the agave inulin-origin products produced by said 14th and 15th forms, respectively.

The 18th form of the present invention is a dietary fiber-enriching feed characterized in that a pomace of said crushed plant piece is mixed after said sap was squeezed by the production method according to any of said first to nine forms, and agave inulin at least is contained as said dietary fiber.

### Effect of the Invention

According to the first form of the present invention, when pina including inulin of high concentration is used as agave plant, the manufacture quantity of inulin increases, so that the cheap, stable and mass supply of inulin is enabled on the basis of stable vegetation of agave plant in Mexico. The shape of plant piece is arbitrary such as cubic, granular, powder-shaped, tabular and flake-shaped, the preferred size ranges from several cm to powder, and the various kind of machine such as well-known beating machine and shredder can be used. As described below, when the plant piece is heated, the heat effect becomes high so that the size of the plant piece crushed finely from agave plant is small, and the heating time can be shortened. Additionally, in the present invention, except the second form stated below and another form with the use of this, squeeze may be done without heating of said plant piece or crushed plant piece, and in the non-heating case, there is no increase of personnel expenses and energy expenditure cost to perform facility having the heating means, its manipulation, maintenance and control, so that the comparatively cheap highly water-soluble agave inulin can be provided.

Since the vacuole of agave plant is crushed by adding of force, preferably twist force in order to produce the sap from said plant piece, it is possible to obtain the sap efficiently by squeezing of said crushed plant pieces. In the present invention, there are required two processes of crush and squeeze of vacuole by all means, but said two processes are simultaneously performed by use of well known squeezing machine, for example orange squeezing machine, press squeezing machine, cutter, juicer and other squeezing machine can be utilized. In particular, when hammer mill and stone mill etc. are employed for vacuole crush, it is possible to rise up the efficiency. Inulin extracted from agave plant is far highly water-soluble in comparison with inulin of chicory or Jerusalem artichoke etc., and the highly water-soluble agave inulin dissolves in said sap. However, because many impurities aside from inulin are contained in said sap, it is necessary to remove said impurities. As this removal means, activated carbon, anion exchange resin, cation exchange resin, absorption resin, filter, separation membrane, safe microorganism flocculant, and the other removal means can be used. In this way, the agave inulin solution in which highly water-soluble agave inulin dissolved is produced.

According to the second form of the present invention, since the plant pieces are softened by heat and the heat temperature is set in less than or equal to 100° C., it can be suppressed that inulin is hydrolyzed by enzyme and it becomes possible to produce highly water-soluble agave inulin with high efficiency. In particular, if the heat temperature of plant piece is set in the range of 80° C.-100° C., the softening of plant piece is promoted, and at the same time, it is possible to inactivate enzyme such as inulin degrading enzyme (inulinase) and lipoxygenase making grassy smell contained in agave inulin by heating at temperature more than 80° C. That is to say, it is prevented that inulin is hydrolyzed by enzyme during the heating, and there is smashed enzymatic action that generates terpene-like smell, grassy smell and strong bitterness on the basis of self-protection of agave plant. Simultaneously, microorganism in agave plant is sterilized by this heat and the propagation of microorganism is prevented.

The heat time is selected from desired time in the range of 5 min-180 min and it is appropriately adjusted in accordance with weight of plant piece to be heated and plant piece size. Inactivation of enzyme cannot be achieved within 5 min, and the softening of plant piece is insufficient. Heat energy cost increases for 180 min or more, and the acid hydrolysis of inulin is promoted by body water and fruit pulp acid which agave plant holds, so that inulin quantity reduces. The heating means can use various heating devices well-known, by way of example only, steam heating device, electric heating device, gas heating device, oil heating device, infrared heating device, microwave heating device and other heating device can be used. Even combustion heat of coal and wood is not minded. Even if it is the same steam heating device as tequila production, energy cost do not increase that much in the case of short time heating and penetration of free water to the agave plant body can be ignored.

According to the third form of the present invention, when the plant piece is mixed with the acid neutralizer, the plant piece is held in neutralization state, and acid hydrolysis of inulin can be intercepted. As a result, reduction of inulin quantity in the plant piece can be prevented and the effect that inulin production efficacy can be improved is realized. As the acid neutralizer, alkali chemicals such as calcium carbonate, calcium hydroxide, sodium carbonate and sodium bicarbonate, OH type anion exchange resin and other neutralizer can be used. An acid neutralizer may be mixed and added to solvent.

In addition, a softening accelerator promoting the softening of plant piece and other additive may be mixed and heated.

According to the fourth form of the present invention, since the treatment of plant piece is carried out under the condition that water is not added forcibly, the energy cost to heat additive water can be reduced, so that it can be contributed to reduction of price of agave inulin. At the same time, as water is not added, there is no osmosis of water to the agave plant body and there is the advantage that agave inulin solution of high concentration can be produced because of no extra water. Therefore, as the heating device which does not employ water, steam heating device, electric heating device, gas heating device, oil heating device, infrared heating device, microwave heating device and other dry-type heating device can be used, and for example, as high temperature heating device of short time, microwave heating device like microwave oven is simple, easy and effective.

According to the fifth form of the present invention, since said sap is prepared at pH6-8, the pH of said sap is forcibly neutralized and it becomes possible to intercept the acid hydrolysis of inulin, so that there is no reduction of inulin content in said sap and there is the advantage that the production quantity of inulin can be increased. When it is considered that pH of said sap Juice) of pina after heat is 4-4.5,alkali chemicals such as calcium carbonate, calcium hydroxide, sodium hydroxide, sodium carbonate and sodium bicarbonate, and OH type anion exchange resin etc. can be used as pH preparation agent. Water-insoluble pH preparation agent can be removed by filtration etc.

According to the sixth form of the present invention, since said impurities are adsorbed and removed from said sap by the adsorbent, the high purity agave inulin solution not including impurities such as solid can be produced. As said adsorbent, it can be preferably utilized the porosity adsorbent such as activated carbon, zeolite, alumina, molecular sieve and adsorption resin, and especially, adsorption resin therein is more preferred. In the case of adsorption resin, adsorption of impurity and desorption of adsorbed impurity (recovery) are easy, but adsorbent capable of adsorption and desorption can be utilized. As adsorption resin, concretely, there can be used Amberlite XAD made by Rohm & Haas company and HP20 made by Mitsubishi Kasei company, but needless to say, the other adsorption resin can be used, too. If said adsorbent is filled within the column and the sap is flown into, said impurities are removed and only the solution dissolving agave inulin can be obtained. Additionally, adsorption efficacy is approximately similar in the range of room temperature to 100° C., and it is effective because it is hard to affect location of adsorption treatment factory and temperature condition of sap.

According to the seventh form of the present invention, when the impurities adsorbed by the adsorbent are eluted into the mixed solution of water and organic solvent, it becomes possible to reuse said adsorbent, so that it is advantageous that treatment cost gets cheap because multiple use of the same adsorbent becomes possible. As said organic solvent, hydrophilic solvent such as alcohol and acetone having compatibility with water is effective, so that it is possible to reproduce adsorbent efficiently because organic substance in the impurities is absorbed into organic solvent and water-soluble substance is absorbed into water.

According to the eighth form of the present invention, by distilling said mixed solution, it becomes possible to recover said impurities as by-product. Since the impurities eluted in the mixed solution of water and organic solvent are dissolved dispersely, said impurities remain by separating said solvents. In said impurities, saponin of bitterness component (non-volatile component)and terpene—aldehyde of smell component (volatile component) etc. are included, so that the substances such as said saponin, terpene and aldehyde are generated as by-product. Saponin is expected in application to food additive and pesticide such as insecticide and herbicide. Furthermore, Volatile substance can be expected in application to smell component of tequila-related ingesta and pesticide.

According to the ninth form of the present invention, if free water is removed from agave inulin solution produced as described before, solid agave inulin can be produced.

Removal means can use well-known means of evaporation, membrane separation and so on. Agave inulin is highly water-soluble, and it can dissolve in about ⅓ water of inulin weight, so that liquid inulin and solid inulin with high quality can be obtained by minimizing of hydrolysis.

According to the tenth form of the present invention, agave inulin solution is provided by the production method of said first to eighth forms. As explained above, solubility of agave inulin is higher water-soluble than inulin obtained from asteraceae plant and it is advantageous that agave inulin solution of wide concentration can be provided. Besides, water activity of concentratus agave inulin solution is low. As water activity of 75% inulin aqueous solution is 0.83, microorganism can not multiply and it is worthy of a long-term conservation. In the case of agave inulin aqueous solution, since misce with other plant extract can be done freely, agave inulin can be provided to market as juice in large quantities and it is optimum for spread of inulin having good efficacy.

According to the 11th form of the present invention, solid agave inulin is provided by the production method of said ninth form. In the shape of solid agave inulin, various shape such as powder, granule and solid-shaped bulk can be prepared depending on their applications. If tablet form is supposed to be a supplement, it can dissolve easily in body because of its high water-solubility when it is taken, so that it contributes to breeding of lactobacillus bifidus in intestine and the inulin effect can be shown in maximum.

According to the 12th form of the present invention, various by-products of agave plant are provided by the production method of said eighth form. From agave plant, not only inulin but also by-product such as saponin and terpene can be recovered, and needless to say, these by-products can be utilized for their endemic uses.

According to the 13th form of the present invention, agave inulin is extracted from pomace of said crushed plant piece, and then, inulin contained in agave plant can be used with high efficiency. Inulin considerably remains in the pomace that is squeezed sap, besides the vacuole is crushed. When water or hot water is added to the pomace and it is pressurized, the remaining inulin is extracted and the agave inulin extract can be obtained. If the impurities are removed from this extract, the agave inulin solution in which highly water-soluble agave inulin dissolved can be produced, so that saccharide and their processed food can be provided by hydrolyzing of it. In addition, when pH preparation agent is dissolved in the agave inulin extract and its pH is neutralized forcibly, the acid hydrolysis of inulin can be intercepted. Furthermore, as described earlier, if heat temperature of plant piece is set in the range of 80° C.-100° C., the softening of plant piece is promoted and simultaneously, inulin degrading enzyme contained in agave plant and enzyme making grassy smell can be inactivated.

According to the 14th form of the present invention, inulin extracted from the squeezed pomace is hydrolyzed by use of acid catalyst and enzyme (inulinase etc.), and then the alcoholic drinks such as pulque being liquor, wine drink and beer drink can be provided by fermenting the saccharide solution based on fructose, therefore effective utilization of inulin can be planned. Furthermore, distilled liquor such as tequila can be provided with distilling of the fermenting liquid.

According to the 15th form of the present invention, inulin extracted from said pomace is hydrolyzed by use of acid catalyst and enzyme (inulinase etc.), and then the agave syrup can be produced by concentrating the saccharide solution based on fructose, therefore effective utilization of inulin contained in agave plant can be planned.

According to the 16th and the 17th forms of the present invention, since various kinds of alcoholic drinks and agave syrup produced using said pomace are provided, it is possible to utilize the agave plant effectively and to reduce the development of waste.

According to the 18th form of the present invention, as said pomace in which agave inulin component remains is mixed in animal feed, it is possible to supply the soluble and insoluble dietary fiber for domestic animal etc. In this case, the pomace is just used in the conditions of sterilization safekeeping and drying. Additionally, the dried or raw pomace can be used with crushing more in accordance with its purpose, and the pomace can be used effectively.

### BEST MODE FOR CARRYING OUT THE INVENTION

The following examples are shown to explain the present invention and the present invention is not limited to these examples.

### Example 1

### Relation of Heat Time and Acid Hydrolysis

Pina of agave plant is divided into two pieces by a saw, and the plane waste 7.5 kg were got from its cut surface by use of plane. The plane waste 0.5 kg was left as a control in the room and the remaining plane waste 7 kg was divided into two groups by 3.5 kg. Calcium carbonate of 17.5 g was uniformly sprinkled on one group and after it was divided by 0.5 kg, they were filled in seven polypropylene bags, respectively and after air was pushed out from the bag, its mouth was closed with polypropylene string, so that seven polypropylene pouches filled with 0.5% calcium carbonate were obtained. In addition, from the remaining group, seven pouches filled with plane waste of 0.5 kg were obtained without sprinkling of calcium carbonate.

After the 14 polypropylene pouches were put in a large-sized microwave oven, said polypropylene pouches expand by steam based on switch on, it is waited the situation that said polypropylene pouches shrink by switch off after the considerable expansion, and they are heated again by switch on after they shrank, so that they were heated in said microwave oven by repeating on-off of the switch. The temperature of plane waste was measured with thermister thermometer and the mean temperature of all process of heat was about 90° C. At this temperature, enzyme such as inulinase and lipoxygenase is inactivated and is no enzymatic hydrolysis of inulin. At each time point of 5 min,10 min, 60 min, 90 min, 180 min and 270 min after start of heating, each one piece of polypropylene pouch from both groups was taken out from the microwave oven, and the last piece of polypropylene pouch from both groups was taken out at time point of 360 min passing, and the heating of 14 polypropylene pouches was finished.

The softening degree of heated plane waste taken out from the polypropylene pouch of each passing time point was measured, and then it was squeezed with the orange squeezing machine. Fructose concentration of juice (sap) of obtained each time point is measured and the results were summarized in table 1. Softening degree is small in five minutes, but squeezing became slightly easy in comparison with non-heating and the easiness of squeezing increased with passing of heat time. It was found from view point of squeezing that heat time more than five minutes is necessary and more than ten minutes is preferable. In addition, Since fructose concentration was about 2-3% in the heat time of 5 min to 60 min and it was about 2% even in control (non-heating), it was found that the acid hydrolysis does not progress in 5 min-60 min.

TABLE 1
The effect of CaCO3 affecting fructose generated in plane
waste of pina (% shows fructose percent in plane waste)

| Heat Time(min) | 0 | 90 | 180 | 270 | 360 |
|---|---|---|---|---|---|
| CaCO3 nothing | 2% | 4% | 6% | 8% | 10% |
| CaCO3 contain | 2% | 2.3% | 2.6% | 2.9% | 3.1% |

As found from Table 1, in the case that calcium carbonate is not added, though pH of pina inside before heating is 5, the pH of the pina inside becomes about 4.5 when the heating time gets longer, and it is found that the acid hydrolysis of inulin is promoted by heating and the fructose concentration increases gradually. The concentration became 4% at 90 min, 6% at 180 min, 8% at 270 min and 10% at 360 min. On the other hand, when insoluble calcium carbonate is added, it is demonstrated that pH is kept about 6.5 and hydrolysis hardly progresses.

From the above, it is confirmed that acid hydrolysis does not progress by heat time of 5 min to 60 min. The phenomenon that fructose concentration increases along with heat time shows that inulin receives acid hydrolysis. From a point of view to raise recovery rate of inulin, it was judged that 180 min is the upper limit of heat time. Therefore, the heat time is chosen from the range of 5 min to 180 min and the range is preferably 10 min to 60 min. Because the significance of this heat is inactivation of enzyme, softening of plant piece and pasteurization, a short time heating is effective to suppress the energy cost in the range realizing said effects.

On the other hand, since in the production of tequila, pina is steamed up with steam of 100° C. for about 30 hours, about 90% of inulin is hydrolyzed to fructose by the heat of 30 hours. In the present example, in order to prevent decomposition of inulin, the point that the heat time is extremely shortened is characteristic, and then in this point, the present invention differs from the technical concept of production of tequila at all.

### Example 2

### Difference of Quantity of Juice by Squeezing Machine

One of divided piece of pina in example 1 was made to the plant pieces of cubic cut with 15 mm in length by means of a cutter. Said plant pieces of 1 kg were filled in one polypropylene bag and after air was pushed out from the bag, its mouth was closed with polypropylene string, so that four polypropylene pouches were obtained. After said four polypropylene pouches were put in the large-sized microwave oven, said polypropylene pouches were heated until they expand by steam, and it was waited the situation that said polypropylene pouches shrink a little by stopping the heat, and it was repeated that they are heated until they expand again. All four pouches were heated for 30 min after their first expansion. These four pouches were squeezed with different squeezing machines, and the difference of quantity of juice was tested.

Heat-treated plant pieces were taken out from the first pouch, and they were manually squeezed with compression handle operation by use of the orange squeezing machine. Juice (sap) equal to weight of 55% of plant piece weight was obtained.

Heat-treated plant pieces were taken out from the second pouch, said plant pieces were put in cylinder made by stainless steel having a mobile piston, and they were compressed by use of jack for automobile. Juice equal to weight of 30% of plant piece was obtained from liquid exit of lower part.

Heat-treated plant pieces were taken out from the third pouch, and they were squeezed by use of the cutter and the commercial juicer provided with the centrifugal separator ability (Tescom Juicer TJ20-W). Juice equal to weight of 50% of cubic plant piece was obtained.

Heat-treated plant pieces were taken out from the fourth pouch, and they were compressed by use of the homemade manual type screw press (screw length of about 30 cm). Juice equal to weight of 40% of plant piece was obtained from liquid exit of lower part.

As can be seen from the above, it became clear that the quantity of juice varies by the kind of squeezing machine. It is considered that the more the quantity of juice (sap) is the more the extracted quantity of inulin is. It was found that the orange squeezing machine becomes the most to be 55% in said four kinds of squeezing machine. Therefore, it gets possible to employ the squeezing machine with much quantity of juice arbitrarily selected from various kinds of well known squeezing machine.

### Example 3

### pH Preparation of Juice

The pH and fructose concentration of four kinds of juice obtained just after squeeze in example 2. NaOH was added into said juice of 300 ml and it was prepared to be pH6-8 as follows, and while holding the liquid temperature at 90° C., the fructose concentration was measured after six hours progressed from the pH preparation time. If hydrolysis occurs, the fructose concentration should increase, and if hydrolysis does not occur, the fructose concentration cannot change almost.

(A liquid) Orange squeezing machine: pH5.2, fructose 2%→pH6.0

(B liquid) Jack for automobile: pH5.0, fructose 2%→pH6.5

(C liquid) Commercial juicer: pH5.1, fructose 2%→pH7.5

(D liquid) Screw press: pH5.0, fructose 2%→pH8.0

The fructose concentrations of these 4 liquids after 1 hour, 3 hours and 6 hours from the start of heat six hours became as follows.

| | 1 hour | 3 hours | 6 hours |
|---|---|---|---|
| (A liquid) Orange squeezing machine: | 2% | 2.2% | 2.4% |
| (B liquid) Jack for automobile: | 2% | 2.2% | 2.4% |
| (C liquid) Commercial juicer: | 2% | 2.2% | 2.4% |
| (D liquid) Screw press: | 2% | 2.2% | 2.4% |

From the above results, it was found that if the pH is prepared to be 6-8, the hydrolysis hardly progress in juice (inulin solution) and the conversion of inulin to fructose is prevented. It is proved that inulin is stably held in solution by this pH preparation. In the case that inulin is produced in large quantity, it is necessary to perform the process such as squeeze, filtration and purification under heating to prevent the reproduction of microorganism. On that occasion, it is necessary for mass production of inulin that hydrolysis does not occur even by heating, and it is demonstrated that it can be realized by preparing the juice to be pH6-8.

### Example 4

### Purification of Inulin Aqueous Solution by Adsorbent and Inulin Solid

From juice (A liquid, B liquid, C liquid, D liquid) obtained after 6 hours heating based upon the example 3, the impurities were adsorbed and removed by the following adsorbent, and the highly water-soluble agave nulin was produced.

Said A liquid was refined by means of activated carbon, anion exchange resin and cation exchange resin, and after it was evaporated by means of rotary evaporator, exsiccation was done and white solid was got, but there were smell and bitterness peculiar to agave plant.

After said B liquid was flowed into column filled with adsorption resin HP20 made by Mitsubishi Kasei Inc., it was concentrated by use of the rotary evaporator, so that there was obtained the highly water-soluble agave inulin solution including inulin of 80%, in which there are no smell and no bitterness peculiar to agave plant and it has mild sweetness and pale yellow color.

After said C liquid was flowed into column filled with adsorption resin HP20 made by Mitsubishi Kasei Inc., it was evaporated by means of rotary evaporator, exsiccation was done and white solid was obtained. This white solid has no smell and no bitterness peculiar to agave plant and has mild sweetness, and therefore the highly water-soluble agave inulin solid is produced.

Said D liquid was refined by means of activated carbon, anion exchange resin and cation exchange resin, and after it was flowed into column filled with adsorption resin Amberlite XAD made by Rohm & Haas Inc., spray-dry were done, so that there was obtained the white powder solid, in which there are no smell and no bitterness peculiar to agave plant and it has mild sweetness. This powder is the highly water-soluble agave inulin powder.

### Example 5

### Regeneration of Adsorbent and Recovery of Agave By-Product

One of divided piece of pina left in example 1 was made to the plant pieces of cubic cut with 15 mm in length by means of the cutter. Said plant pieces of 2 kg were filled in one polypropylene bag and after air was pushed out from the bag, its mouth was closed with polypropylene string, so that polypropylene pouch was obtained. After said pouch was put in the microwave oven, said pouch was heated until said pouch expands by steam, and it was waited until said pouch shrinks a little by stopping the heat, and it was repeated to heat it until expanding again. The pouch was heated for 30 min after the first expansion.

The plant pieces 2 kg taken out from this pouch were squeezed with the orange squeezing machine and juice of 1 L was produced. Said juice 1000 ml was flowed to column filled with adsorption resin HP20 and the impurities were adsorbed by adsorption resin HP20. This column was washed with pure water of 200 mL, and by washing it with the mixed liquid of ethanol of 50 ml and pure water of 50 ml, the coloration component adsorbed in column was eluted and came back to original white. The thing that the effluent was vaporized is washed in hexane and the saponin having bitterness was included in large quantities in the dehumidified solid (50 mg). In addition, smell component such as terpene was included in hexane solution. As thus described, adsorbate recovered from the adsorbent includes nonvolatile saponin, volatile terpene and aldehyde. Saponin is expected to application for pesticide such as food additive, insecticide and herbicide. Furthermore, volatile substance can expect the application for smell component of tequila-related ingesta and pesticide etc.

### Example 6

### Utilization of Pomace

It is ensured that available agave inulin remains in the pomace which is squeezed the sap juice), and when said pomace added hot water (even water is preferable) is pressurized, agave inulin remaining in pomace is extracted. This agave inulin extract is hydrolyzed by use of inulinase and the sugar solution based on fructose is generated. This sugar solution can be used to production of alcoholic drinks by fermentation, and agave syrup can be produced with concentrating of it. Additionally, since it is confirmed that agave inulin component remains, by mixing the pomace with feed of domestic animal, it is possible to produce the dietary fiber enriched feed supplying the soluble and insoluble dietary fiber.

### [Result and Discussion]

By said compression after heating, the juice increased 10-50% in quantity is obtained in comparison with the cubic cut plant pieces of non-heat, and the juice obtained after heating has clearly lesser coloration and lower sweetness than that of non-heat. The bitterness and obstinate smell of juice could not be removed by activated carbon, but it could be removed with adsorbent well. Besides, bitterness component, smell component and coloration component adsorbed on the adsorbent can be recovered with liquid mixture of water-organic solvent and the adsorbent can be reused. Thus obtained inulin can dissolve in water less than ¼ of inulin weight and it became the low viscous aqueous solution which has a little sweetness with light brown color and scentlessness. Though agave inulin has the high degree of polymerization, it can be considered that this high solubility is conceivable with numerousness of ramification.

### INDUSTRIAL APPLICABILITY

At present, the greater part of inulin sold in the market is produced from chicory of asteraceae, and its solubility is low. In order to increase the solubility, the partial hydrolysis is performed, and it is marketed by changing its name to oligofructose. Even if agave inulin of the present invention is compared with said oligofructose, its solubility is high still more, and this very excellent solubility is expected to open new niche in the industry products in which the solubility is demanded like the market of juice and drink. In addition, as inulin having high water-solubility is easy to be hydrolyzed by lactobacillus bifidus in intestine (bowel), the use efficacy is high in comparison with low water-soluble inulin and it is expected that it is more effective as prebiotic.

1. A method for producing highly water-soluble agave inulin comprising the steps of crushing vacuoles containing inulin by giving a force to a plant piece either while or after cutting an agave plant containing said inulin into said plant pieces, squeezing sap of said vacuoles from said crushed plant piece, and producing an agave inulin solution dissolving said highly water-soluble agave inulin by removing impurities from said sap.

2. The method for producing highly water-soluble agave inulin according to claim 1, wherein said plant piece is heated with a temperature of less than or equal to 100 □ during a desirable time in a range of 5 minutes to 180 minutes while and/or after cutting said agave plant.

3. The method for producing highly water-soluble agave inulin according to claim 1, wherein said plant piece and/or said crushed plant piece are mixed with an acid neutralizer.

4. The method for producing highly water-soluble agave inulin according to claim 1, wherein the treatment of said plant piece is carried out under the condition that water is not forcibly added.

5. The method for producing highly water-soluble agave inulin according to claim 1, wherein said sap is prepared in a range of pH 6-8.

6. The method for producing highly water-soluble agave inulin according to claim 1, wherein said impurities are adsorbed and removed from said sap by an adsorbent.

7. The method for producing highly water-soluble agave inulin according to claim 6, wherein said impurities adsorbed by said adsorbent are eluted in a mixed solution of water and organic solvent, and said adsorbent is reused after said elution.

8. The method for producing highly water-soluble agave inulin according to claim 7, wherein said eluted impurities are recovered as a by-product by distilling said mixed solution.

9. The method for producing highly water-soluble agave inulin according to claim 1, wherein solid agave inulin is produced with removing water from said agave inulin solution.

10. An agave inulin solution characterized in that said agave inulin solution is produced by the production method according to any of claims 1 to 8.

11. A solid agave inulin characterized in that said solid agave inulin is produced by the production method according to claim 9.

12. A by-product characterized in that said by-product is recovered by the production method according to claim 8.

13. An agave inulin extract characterized in that said agave inulin extract is obtained by extracting inulin through adding water or hot water to a pomace remained after said sap was squeezed by the production method according to any of claims 1 to 9.

14. A method for producing an alcoholic drink characterized in that a sugar solution containing fructose as a main component is generated by hydrolyzing said agave inulin extract according to claim 13 by using of an acid catalyst or an enzyme, and said alcoholic drink is produced by distillation while or after fermenting said sugar solution.

15. A method for producing an agave syrup characterized in that a sugar solution containing fructose as a main component is generated by hydrolyzing said agave inulin extract according to claim 13 by using of an acid catalyst or an enzyme, and said agave syrup is produced by concentrating said sugar solution.

16. An alcoholic drink characterized in that said alcoholic drink is produced by the production method of said alcoholic drink according to claim 14.

17. An agave syrup characterized in that said agave syrup is produced by the production method of said agave syrup according to claim 15.

18. A dietary fiber-enriching feed characterized in that a pomace of said crushed plant piece is mixed after said sap was squeezed by the production method according to any of claims 1 to 9, and agave inulin at least is contained as said dietary fiber.
